(19) United States
(12) Patent Application Publication
(10) Pub. No.: US 2025/0384288 A1
(43) Pub. Date: Dec. 18, 2025

(54) CONTEXTUAL CLASSIFICATION OF TABULAR DATA FOR SELF-ATTENTION

(71) Applicant: The Toronto-Dominion Bank, Toronto (CA)

(72) Inventors: Valentin Patrick Marie Thomas, Toronto (CA); Junwei Ma, Toronto (CA); Anthony Lawrence Caterini, Toronto (CA); Rasa Hosseinzadeh, Toronto (CA); Keyvan Golestan Irani, Aurora (CA); Guangwei Yu, Toronto (CA); Maksims Volkovs, Toronto (CA)

(73) Assignee: The Toronto-Dominion Bank, Toronto, ON (CA)

(21) Appl. No.: 19/239,681

(22) Filed: Jun. 16, 2025

Related U.S. Application Data
(60) Provisional application No. 63/659,873, filed on Jun. 14, 2024.

(51) Int. Cl. G06N 3/09; G06N 3/0455

(52) U.S. Cl. CPC G06N 3/09; G06N 3/0455

(57) ABSTRACT

An example operation may include at least one of storing tabular data in a database, receiving an input sequence by a transformer model that includes global context, generating a query vector from the input sequence, wherein the query vector corresponds to a data record within the tabular data, generating local context comprising at least one additional vector from the input sequence within a proximity threshold to the query vector within vector space, replacing the global context of the transformer model with the local context, and generating an output based on execution of the transformer model with the local context on the query vector and the tabular data.

### CROSS-REFERENCE TO RELATED APPLICATIONS

The present application claims the benefit of U.S. Provisional Patent Application No. 63/659,873, filed on Jun. 14, 2024, the entire disclosure of which is incorporated by reference herein.

This application is related via subject-matter to U.S. patent application Ser. No. 18/817,371, filed on Aug. 28, 2024, and U.S. Patent Application Docket No. 24201-DAI-US-PAT3, entitled “LOCAL CONTEXT GENERATION OF TABULAR DATA USING NEAREST NEIGHBORS,” filed on Jun. 16, 2025, the entire disclosures of which are incorporated by reference herein.

### BACKGROUND

TabPFN is a type of neural network (transformer) that is trained to generate predictions from tabular data. The term “PFN” stands for prior-data fitted network. The TabPFN mode may be trained offline once, to approximate Bayesian inference on synthetic data sets. A TabPFN model typically includes a limited size memory which limits how much input data can be used during the single forward pass. In some cases, tabular data is much larger than the memory of the TabPFN model.

### SUMMARY

One example embodiment provides an apparatus that includes a memory configured to store tabular data, and a processor communicatively coupled to the memory and configured to at least one of receive an input sequence by a transformer model that includes global context, generate a query vector from the input sequence, wherein the query vector corresponds to a data record within the tabular data, generate local context comprising at least one additional vector from the input sequence within a proximity threshold to the query vector within vector space, replace the global context of the transformer model with the local context, and generate an output based on execution of the transformer model with the local context on the query vector and the tabular data.

Another example embodiment provides a method that includes at least one of storing tabular data in a database, receiving an input sequence by a transformer model that includes global context, generating a query vector from the input sequence, wherein the query vector corresponds to a data record within the tabular data, generating local context comprising at least one additional vector from the input sequence within a proximity threshold to the query vector within vector space, replacing the global context of the transformer model with the local context, and generating an output based on execution of the transformer model with the local context on the query vector and the tabular data.

A further example embodiment provides a computer readable storage medium comprising instructions, that when read by a processor, cause the processor to perform at least one of storing tabular data in a database, receiving an input sequence by a transformer model that includes global context, generating a query vector from the input sequence, wherein the query vector corresponds to a data record within the tabular data, generating local context comprising at least one additional vector from the input sequence within a proximity threshold to the query vector within vector space, replacing the global context of the transformer model with the local context, and generating an output based on execution of the transformer model with the local context on the query vector and the tabular data.

### BRIEF DESCRIPTION OF THE DRAWINGS

FIGS. 1A-1B are diagrams illustrating a system for retrieving a subset of tabular data for input to an AI model according to examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a chatbot service that utilizes an AI model.

FIG. 3A is a diagram illustrating an operating environment of a system that provides scalable in-context learning and inference on large and complex datasets according to examples and features of the instant solution.

FIG. 3B is a diagram illustrating a process of fine-tuning and sharing of context between queries according to examples and features of the instant solution.

FIGS. 4A-4C are diagrams illustrating a process of extracting table data that fits into a limited-size memory of an AI model according to examples and features of the instant solution.

FIG. 5 is a diagram illustrating an example of a transformer model according to the examples and features of the instant solution.

FIG. 6A is a diagram illustrating a process of generating global context according to the examples and features of the instant solution.

FIG. 6B is a diagram illustrating a process of replacing the global context with local context according to the examples and features of the instant solution.

FIG. 6C is a diagram illustrating a process of determining the local context according to the examples and features of the instant solution.

FIG. 7A is a diagram illustrating a method of replacing global context with local context according to examples and features of the instant solution.

FIG. 7B is a diagram illustrating another method of replacing global context with local context according to examples and features of the instant solution.

FIG. 8 is a system diagram illustrating a computing environment according to the instant solution's example features, structures, or characteristics.

### DETAILED DESCRIPTION

The instant solution pertains to in-context learning on computer systems, hosted compute infrastructure, Central Processing Units (CPU), Graphics Processing Units (GPU), Neural Processing Units (NPU), Tensor Processing Units (TPU), other processing units, embedded computer systems, computer networks, wired and wireless compute devices, physical or virtual compute nodes, and more specifically to transformer-based in-context learning on tabular data sets. The instant solution additionally relates to systems and procedures, i.e., programming and configuration, for said in-context learning.

Tabular data is a pervasive modality spanning a wide range of domains, and the inherent diversity poses a considerable challenge for deep learning. Transformer-based in-context learning has shown promise on smaller and less complex datasets but have struggled to scale to larger and more complex ones.

A TabPFN model is a type of artificial intelligence (AI) model that may include a trained transformer model (“transformer”) that can perform supervised classification for small tabular datasets without hyperparameter tuning. The TabPFN model may perform in-context learning (ICL) and learn to make predictions using sequences of labeled examples given in the input without further parameter updates. TabPFN is a Prior-Data Fitted Network (PFN) and is trained offline once. TabPFN, however, is practical on small tabular dataset.

A transformer model is a type of neural network that excels at processing sequences of input data by learning relationships between words or tokens within the input sequence. It is particularly effective at understanding context due to its ability to handle long-range dependencies through a self-attention mechanism. The self-attention mechanism causes the transformer model to weigh different parts of the input sequence when processing the input sequence. This enables the transformer model to understand relationships between input tokens and increase its accuracy.

In essence, the self-attention mechanism creates a rich, contextual representation of the input sequence, where each element in the input sequence includes a representation that is influenced by the entire sequence. This allows the transformer model to understand the global context and make informed predictions or decisions based on that context.

Self-attention is different than traditional recurrent neural networks (RNNs) that process sequential data step-by-step. For example, the self-attention mechanism allows the transformer model to consider the entire input sequence simultaneously. This means every element (e.g., word in a sentence) can attend to, or relate to, all other elements in the sequence, regardless of their position. A “global” perspective enables transformers to capture long-range dependencies and complex relationships between elements that are far apart in the input sequence, which is used in understanding the overall context.

The self-attention mechanism calculates attention scores that determine how much focus the model is expected to give to each element when processing a specific part of the input. This weighting process identifies the most relevant information within the global context, allowing the model to focus on generating the output. Each element in the sequence is converted into a vector embedding. The self-attention mechanism then calculates an “attention score” with the other elements. This score reflects how relevant each element is to the current element being processed.

The self-attention mechanism may use query, key, and value vectors. To facilitate this, the self-attention mechanism generates three vectors query (Q), key (K), and value (V), for each element in the input sequence. Here, query (Q) represents the element seeking information, key (K) represents the elements being queried, and value (V) holds the information that is passed along when the element is deemed relevant.

The attention scores may be calculated using a dot product of the query and key vectors, then normalized using a softmax function. These scores determine the weight assigned to each element's value vector. The weighted sum of these value vectors becomes the output representation for each element, incorporating information from the entire sequence.

However, processing “global” context for each query vector requires the transformer to consider possible input elements in the input sequence and how it affects the query vector. In the examples and features of the instant solution, the self-attention mechanism can reduce the amount of input elements that are considered by the transformer model by replacing the “global” context of the self-attention mechanism with a “local” context that is generated from tabular data.

In doing so, the examples and features of the instant solution reduce the amount of context that is used during processing of the query vector by the self-attention mechanism, a feedforward network (FFN), and an output layer of an AI model. This can create a faster processing result that uses less processor consumption and less storage space inside the model.

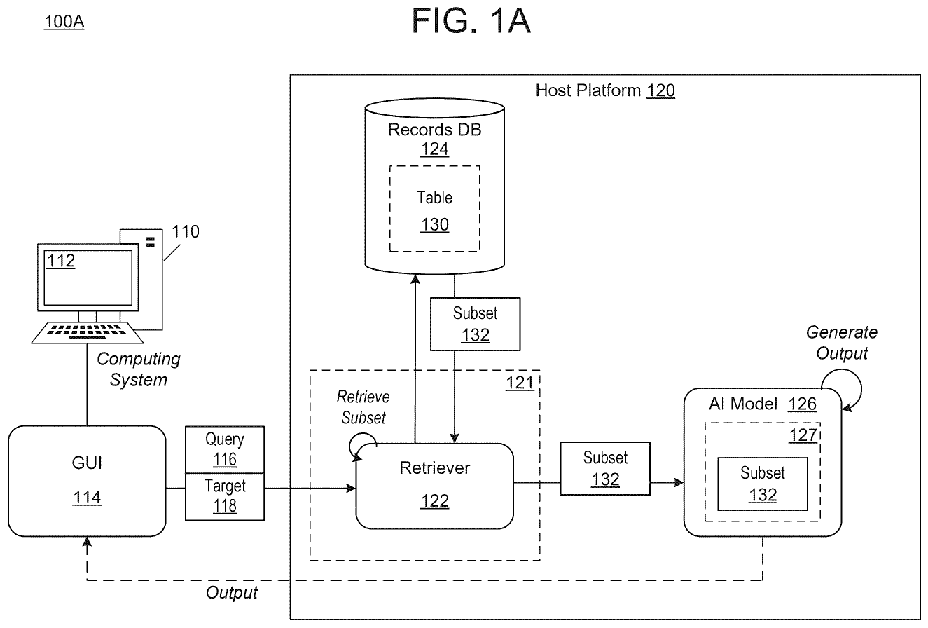

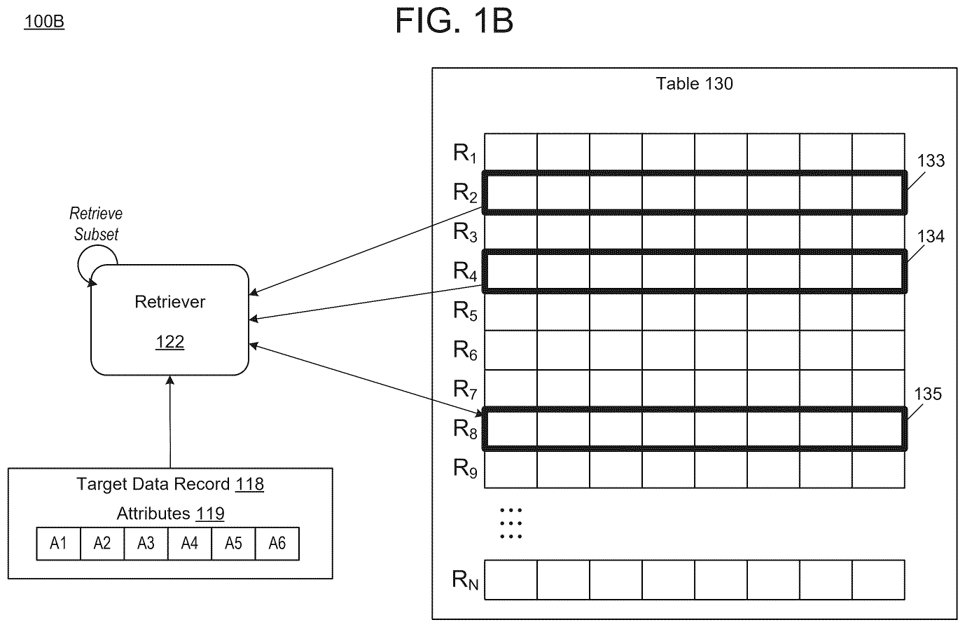

FIGS. 1A-1B illustrate a system for retrieving a subset of tabular data for input to an AI model according to examples and features of the instant solution. For example, FIG. 1A illustrates a process 100A of a host platform 120 that hosts a retriever 122 capable of retrieving a subset 132 of data records from a table 130 that is stored within a records database (DB) 124 and inputting the subset 132 of data records to an AI model 126 during at least one of a training process and an inference process according to examples and features of the instant solution.

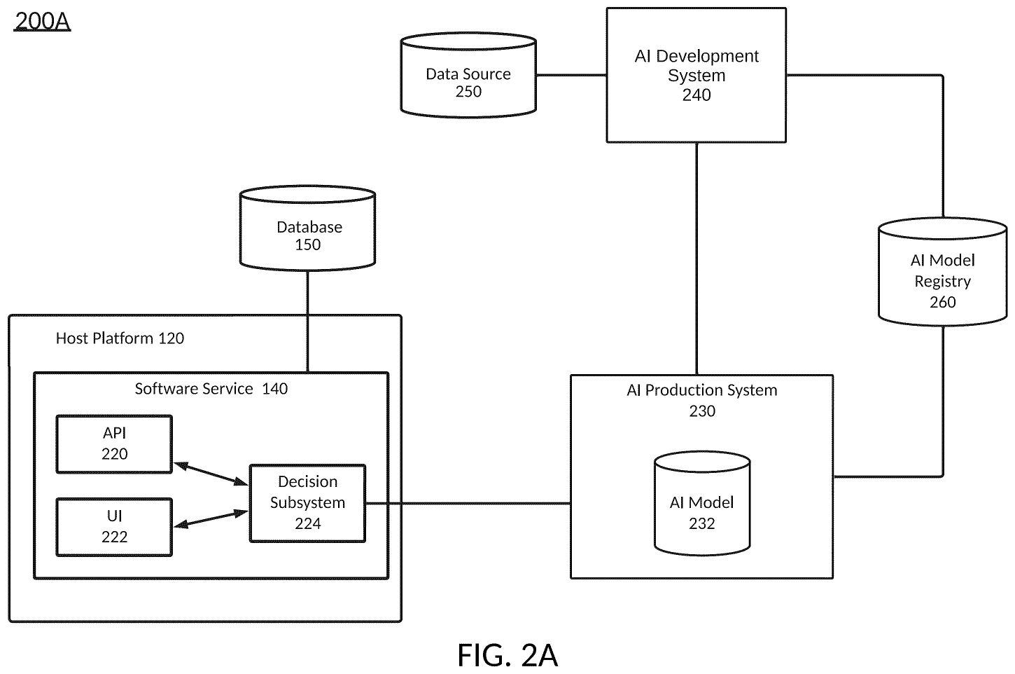

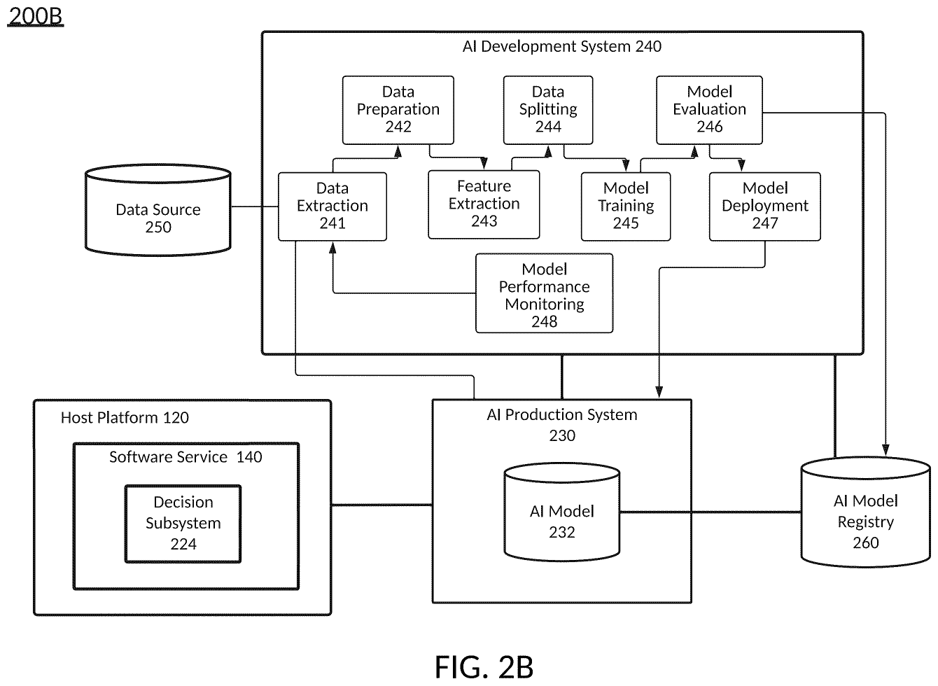

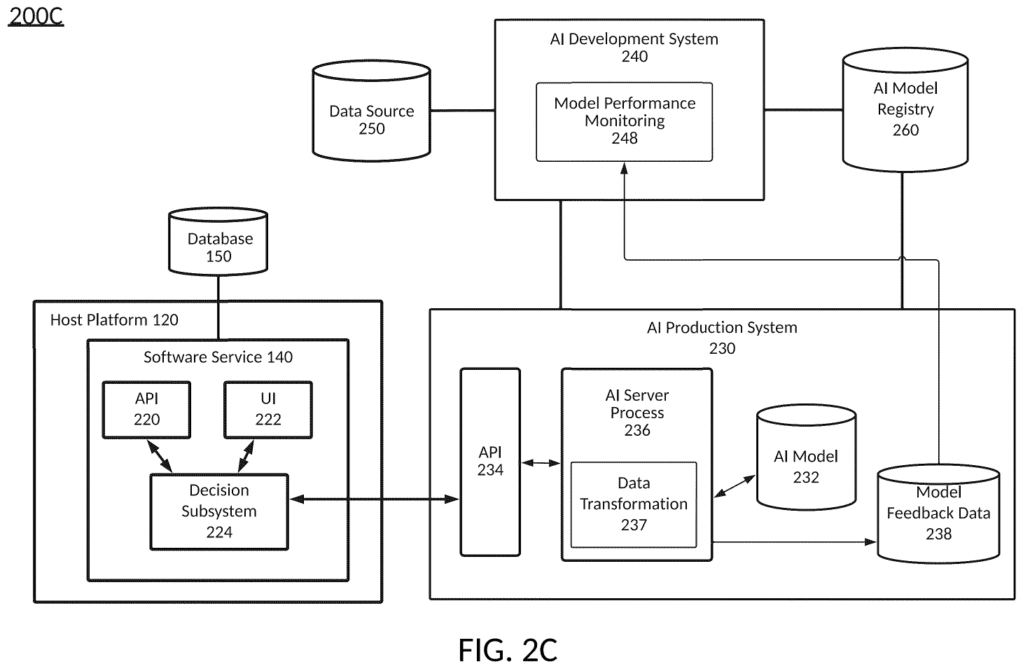

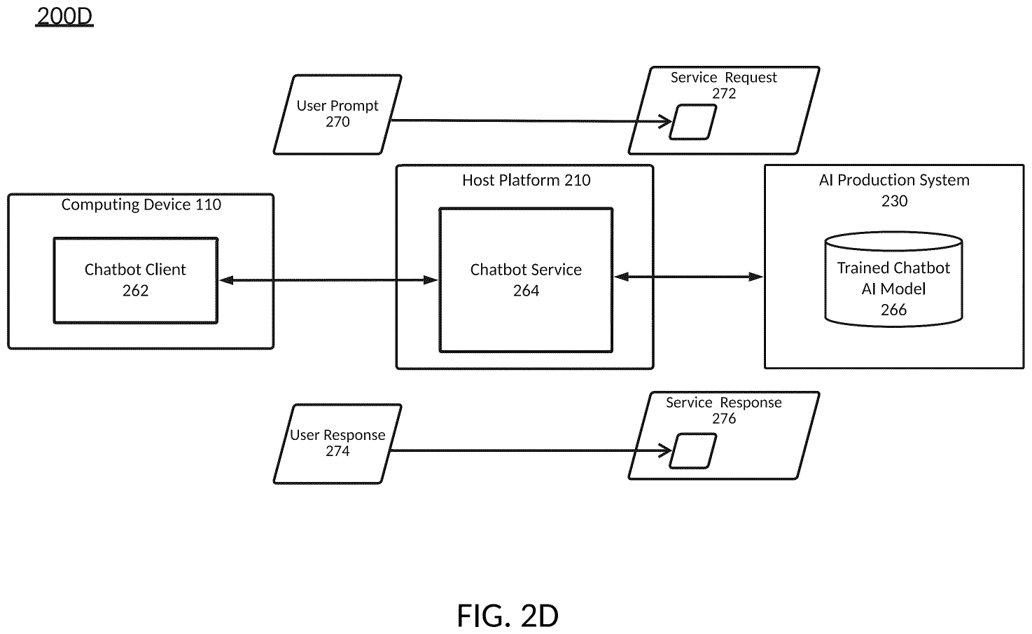

In some examples of the instant solution, AI model 126 may be an example of an AI model 232, described and depicted in FIGS. 2A-2C, and may have been trained in an AI development system 240 or deployed to an AI production system 230, as described and depicted in FIGS. 2A-2C.

Referring to FIG. 1A, the host platform 120 hosts the AI model 126 such as an in-context learning model, TabPFN, or the like. For example, the host platform 120 may be a cloud platform, a web server, a combination of systems, and the like. Meanwhile, the AI model 126 may be an in-context learning model such as TabPFN which performs a single pass (single execution) on the input data very efficiently (e.g., 1 second or less, etc.) when generating a predicted output. The in-context learning model may learn a new task from a small set of examples presented within the context (prompt) at inference time. To enable the efficiency, the AI model 126 may have a limited-size memory 127 capable of holding a limited amount of input data. When there is too much input data to fit into the limited-size memory 127, the input data may be reduced which, when not done properly, can result in the input data not providing accurate examples for the in-context learning model thereby decreasing the predictive performance of the in-context learning model.

A user device, such as a computing system 110 may connect to the host platform 120 via a computer network, such as the Internet. Here, the computing system 110 may access a web page, front-end of an application, etc. of a software application 121 which includes the retriever 122 described herein. The computing system 110 may display a graphical user interface (GUI) 114 of the software application 121 on a display screen or other display device 112 of the computing system 110. Here, a user can enter commands and request execution of the AI model 126. For example, the user can use the GUI 114 to submit a query 116 and a target data record 118, such as attributes of a user that is the subject of the request to the AI model 126.

In the examples and features of the instant solution, the retriever 122 can select the subset 132 of data records such that a size of the subset 132 of data records fits into the limited-size memory 127 of the AI model 126. That is, the retriever 122 can ensure that the input data fits into the limited-size memory 127 ensuring successful execution of a single pass. Furthermore, the retriever can also ensure that the subset of data is relevant to the task being performed such that the in-context learning model is able to accurately learn from the examples.

For example, the retriever 122 can use the target data record 118 to identify other data records (i.e., the subset 132 of data records) in the table 130 within the records DB 124 which are similar in content and use the subset 132 of data records as examples for in-context learning. The subset 132 of data records may include similar attributes as the target data record 118. In addition, the subset 132 of data records may include results that are being asked of the AI model 126, such as a task to be performed. For example, the task to be performed by the AI model 126 may be to determine whether or not to offer a user a charge card. In this example, attributes of the user may be included in the target data record 118. The retriever 122 may use the target data record 118 to identify relevant data records in the table 130 of other users with similar attributes as the user. These other records may also include indications of whether a charge card was provided to the users, and if so, whether the decision was successful (e.g., whether the amount on the charge card is being paid, whether the charge card is in default, etc.).

FIG. 1B illustrates a process 100B of the retriever 122 retrieving a subset of data from the table 130 within the records DB 124 according to the examples and features of the instant solution. Referring to FIG. 1B, the retriever 122 may use the attributes 119 that are contained within the target data record 118 to identify a subset of data records 133, 134, and 135 with similar attributes as the target data record 118. For example, the content within the data records may be converted into vectors, embeddings, or the like, and a comparison of the vectors may be performed to identify similar vectors.

In this example, the data records 133, 134, and 135 may include attribute values similar to the attribute values of the target data record 118. In addition, the data records 133, 134, and 135 may include results or other information that can help the AI model 126 learn from the data records 133, 134, and 135.

Detailed descriptions of the architecture and operation of an AI model that may include a transformer in the instant solution are further described and depicted herein.

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140, executing on the host platform 120 may provide at least one API 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 140 to assist in decision-making. In some examples and features of the instant solution, the software service 140 stores data included in API requests or data generated during processing the API requests into at least one database 150. In some examples and features of the instant solution, software service 140 is a chatbot service.

Software service 140 may provide at least one user interface (UI) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to at least one decision subsystem 224 of the software service 140 to assist with decision-making. In some examples and features of the instant solution, the software service 140 stores data included in UI requests or data generated during processing the UI requests into at least one database 150.

Software service 140 may include at least one decision subsystem 224 that drive a decision-making process of the software service 140. In some examples and features of the instant solution, the decision subsystems 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes at least one AI model 232 that is executed to generate a response, such as, but not limited to, a prediction, a categorization, a UI prompt, etc. In some examples and features of the instant solution, the AI model 232 has been trained to provide chatbot responses. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

In one example, an AI development system 240 is configured to process input data and train an AI model 232, such as a machine learning model. The system receives data from at least one data source 250, and optionally one or more AI Production Systems 230, which may undergo a sequence of preprocessing steps before being used for training a predictive model. The AI development system 240 extracts data related to one or more of the instant features from at least one data source 250 in the data extraction stage 241. This extracted data is then processed through data preparation 242 to normalize or filter relevant information. Feature extraction 243 follows, where meaningful features are identified to increase model performance. The dataset is then split 244 into training and validation subsets.

The AI development system 240 (serving as a machine learning server) is directed to generate a predictive model based on machine learning of the data. The system initiates model training 245 using the prepared dataset. The AI development system 240 selects an appropriate machine learning algorithm and hyperparameters to optimize predictive accuracy. The trained model undergoes model evaluation 246 using validation data to assess performance. When the model meets predefined accuracy thresholds, it is deployed 247 to an AI production system 230 and registered in the AI model registry 260 for use in real-time decision-making.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

FIG. 2D illustrates a chatbot service 200D that utilizes an AI model. Referring to FIG. 2D, a computing device 202 may host a chatbot client 262 which interworks with a chatbot service 264 executing on the host platform 120. Further, the chatbot service 264 utilizes a trained chatbot AI model 266 that is resident on an AI production system 230. In some examples and features of the instant solution, the chatbot client 262 is an example of a service client. In some examples and features of the instant solution, the chatbot service 264 is an example of software service 140 which includes an API 220, a UI 222 and at least one decision subsystem 224. In some examples and features of the instant solution, the trained chatbot AI model 266 is an example of AI model 232 which is hosted on an AI production system 230. In some examples and features of the instant solution, the AI production system 230 includes the internal architectural elements depicted in FIG. 2C.

The chatbot client 262 accepts and captures a user prompt 270 which it sends to the chatbot service 264. Upon receiving the user prompt 270, the chatbot service 264 builds a service request 272 that includes the user prompt 270. In some examples and features of the instant solution, the service request 272 may include a target AI model identifier, such as an identifier to a trained chatbot AI model 266. Once built, the service request 272 is delivered to the AI production system 230. Upon receipt of the service request 272, the AI production system 230 determines the target AI model, such as the trained chatbot AI model 266, and extracts the user prompt 270. In some examples and features of the instant solution, the AI production system transforms the user prompt 270 using Natural Language Understanding (NLU) or Natural Language Processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. In some examples and features of the instant solution, the trained chatbot AI model 266 utilizes neural networks or Natural Language Generation (NLG) techniques in order to determine the appropriate user response 274.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it.

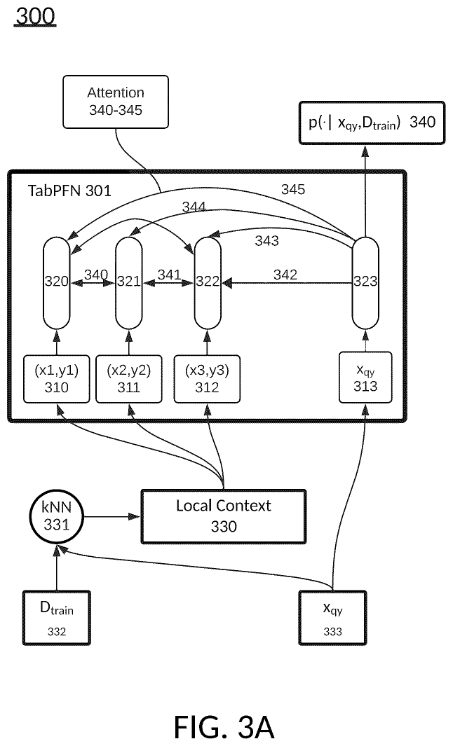

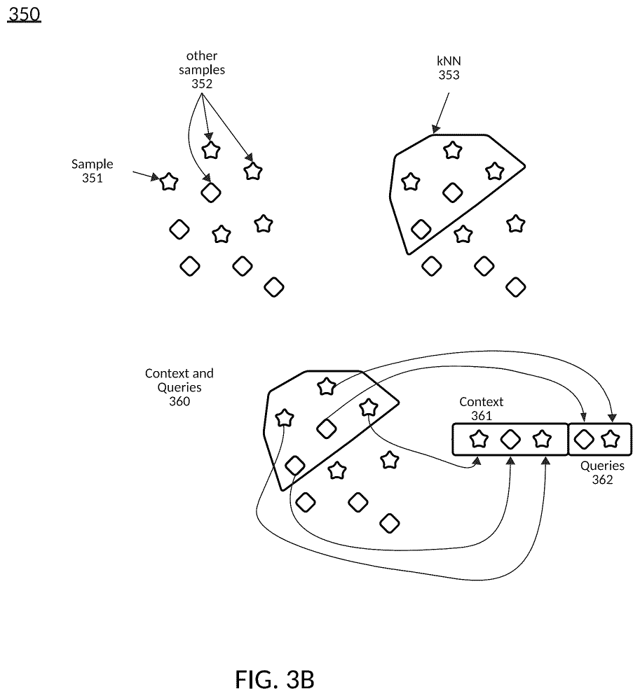

FIG. 3A illustrates an operating environment 300 of a system that provides scalable in-context learning and inference on large and complex datasets according to examples and features of the instant solution. Referring to FIG. 3A, the system may perform fine-tuning using a training dataset Dₜᵣₐᵢₙ 332 and an algorithm for k-Nearest Neighbor (kNN) 331 to establish a local context 330 for an input query. For example, for a query X_{qy} 333, the associated kNN 331 may be determined based on the training dataset Dₜᵣₐᵢₙ 332 and used as local context 330 for inference. The local context 330 may correspond to a subset of rows from a table (and/or a subset of columns from the table, etc.) and may be passed to an in-context learning model such as a TabPFN model 301. In this example, the local context 330 is passed to instances 310, 311, 312, and 313 of the TabPFN model and tokens are calculated 320, 321, 322, and 323, respectively. In addition, attention 340, 341, 342, 343, 344, and 345 may be passed between the instances 310, 311, 312, and 313 associated with the query X_{qy} 333. A response 340 may be generated by the system.

The diagram for the TabPFN model 301 inputs local context 330 into the TabPFN model 301 as opposed to all tabular data. The introduction of a local context 330 instead of using the global context, i.e., all data, is one of the technical benefits of the instant solution. The instant solution may use kNN 331 of a given query point as the context for classification. This modification of the context prior to the TabPFN model 301 in this way empirically allows for both enhanced processing of larger datasets and more complex decision boundaries.

In the context of the instant solution, k-Nearest Neighbor (kNN) refers to the well-known learning classifier. A kNN classifier expresses that the most relevant information to classify a query point X_{qy} is contained in its vicinity.

FIG. 3B illustrates a process 350 of fine-tuning and sharing of context between queries according to examples and features of the instant solution. In this example, a sample 351 may correspond to an input query that has been transformed into a vector and plotted in vector space, and a group of other samples 352 may correspond to rows of data in a table (not shown) that have been transformed into vectors, respectively, and plotted in vector space. Here, the kNN algorithm may identify a boundary 353 within vector space among the other samples that may be used to differentiate other samples that are considered nearest neighbors of the sample 351 and other samples that are not nearest neighbors.

In this example, the other samples within the boundary 353 may be identified as nearest neighbors of the sample 351, while other samples outside of the boundary 353 may be determined as not being nearest neighbors. The rows of table data corresponding to the other samples within the boundary 353 may be used as the local context 330 shown in the example of FIG. 3A, while the rows of table data corresponding to the other samples outside of the boundary 353 may not be used for prediction.

In this example, context and queries 360 represents the samples that are within the boundary 353, context 361 represents the context, and queries 362 represents the queries.

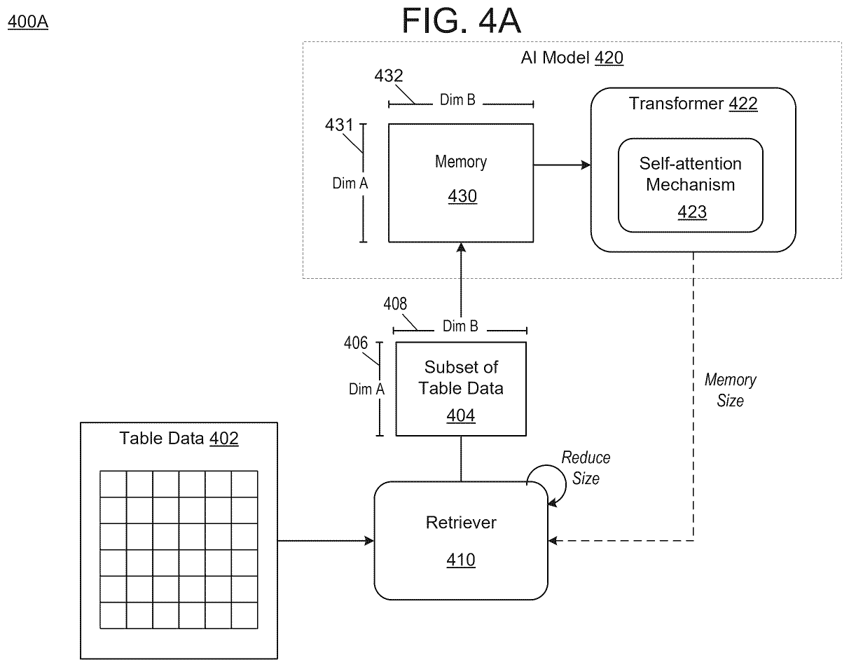

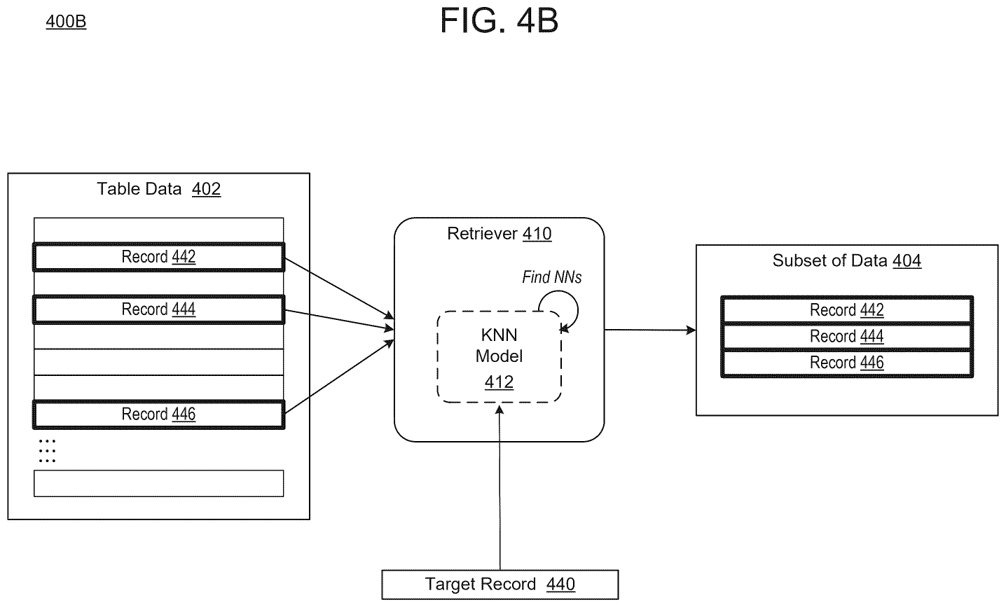

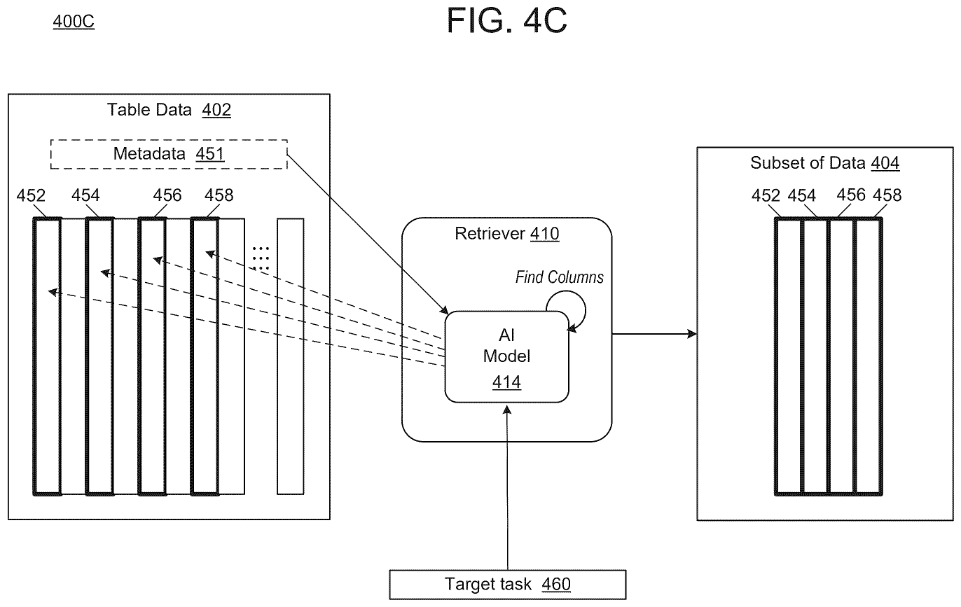

FIGS. 4A-4C illustrate a process of extracting table data that fits into a limited-size memory of an AI model according to examples and features of the instant solution. For example, FIG. 4A illustrates a process 400A of extracting a subset of table data 404 from table data 402 based on a size of a memory 430 of an AI model 420. Referring to FIG. 4A, the AI model 420 may be hosted by a host platform (not shown) and may include a transformer model 422 (such as a large language model, neural network, etc.) which is capable of transforming input data into a predicted output. In addition, the AI model 420 may include a memory 430 capable of holding input data. The transformer model 422 may be configured to generate a predictive output based on a single execution of the transformer model 422 on data stored within the memory 430.

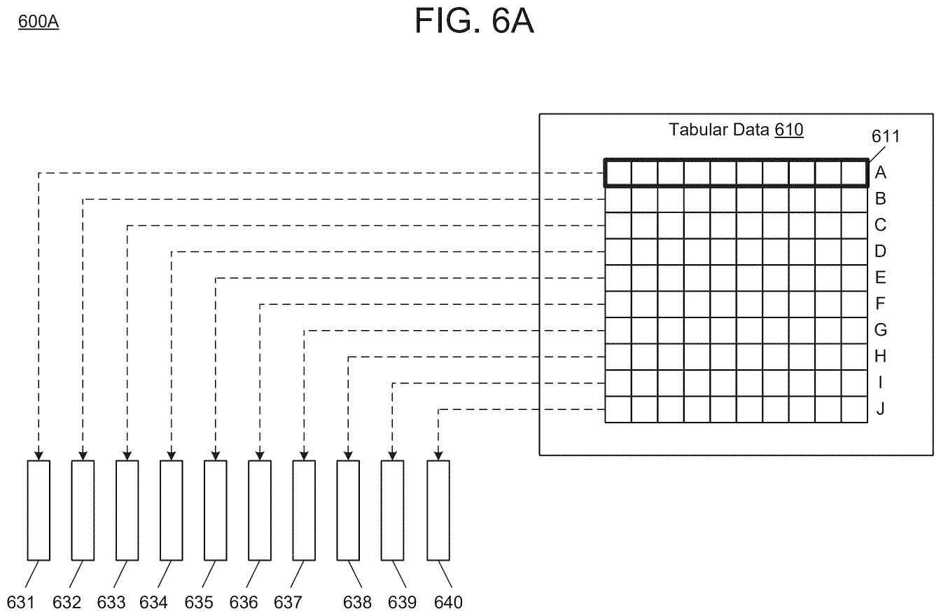

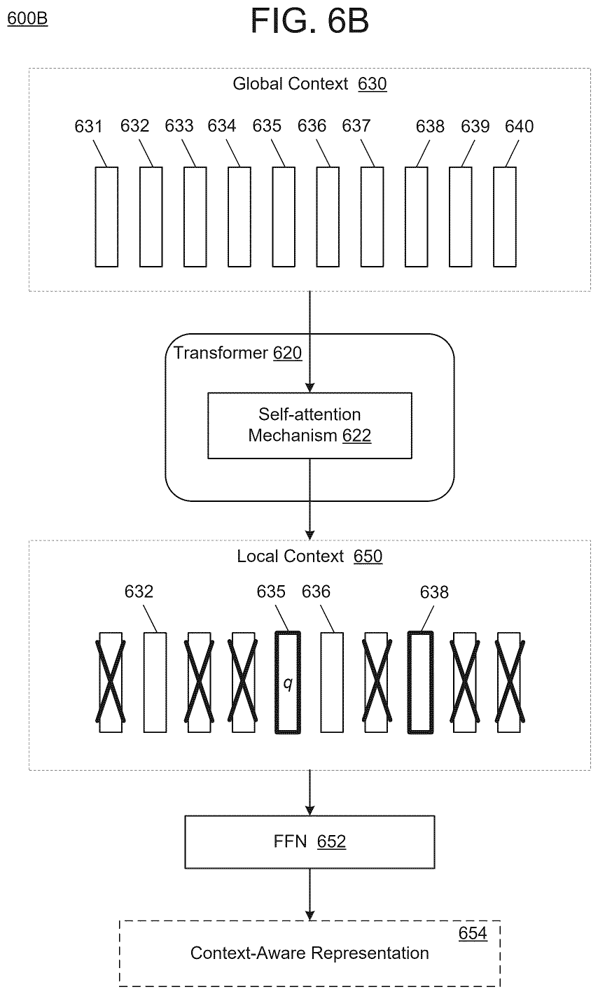

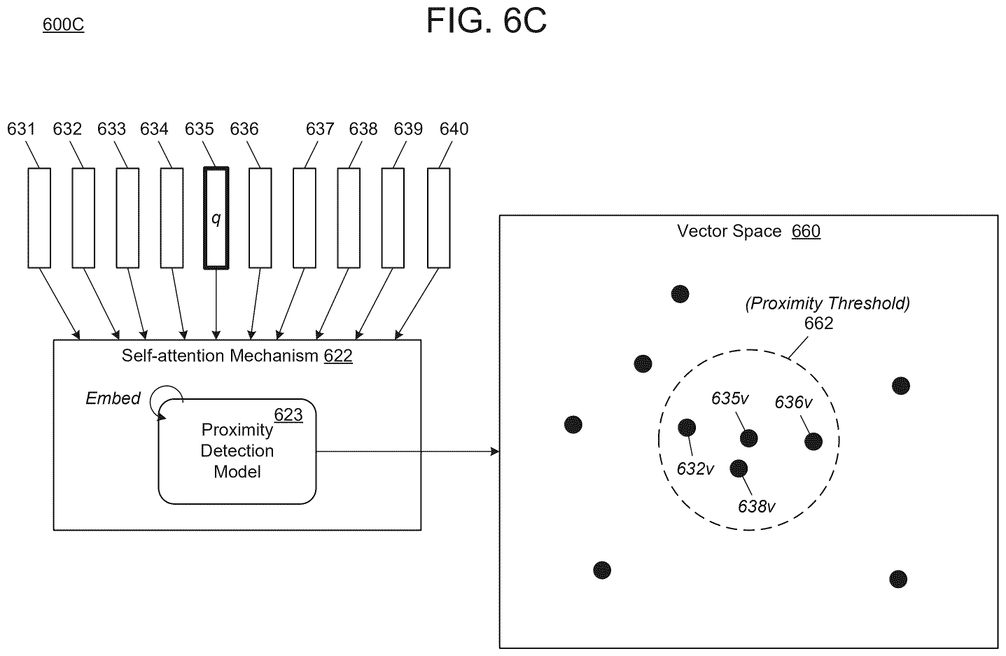

The transformer model 422 may include at least one self-attention mechanism 423 that relies on context from the input sequence to increase the accuracy of the output generated by the transformer model 422. In the examples and features of the instant solution, the at least one self-attention mechanism 423 may use local context, instead of global context. Examples of local context are further described with respect to the examples in FIGS. 6A-6C.

According to various examples and features of the instant solution, the memory 430 may have a limited size. In this example, the memory 430 is shown with dimension 431 and dimension 432, which are a predefined size. However, it should also be appreciated that the memory 430 may include a third dimension (not shown). In this example, the dimension 431 and the dimension 432 of the memory 430 limit the size of data that can be held in the memory 430, for example, to 500 rows of data, 1000 rows of data, 2000 rows of data, or the like. As another example, the dimension 431 and dimension 432 may limit the size of data that can be held in the memory 430 to 10 columns of data, 15 columns of data, 20 columns of data, and the like.

According to various examples and features of the instant solution, the dimensional parameters of the memory 430 may be transferred to a retriever 410 that is configured to retrieve the subset of table data 404 from the table data 402 for input to the transformer model 422. In this example, the retriever 410 may extract the subset of table data 404 such that it has a size (e.g., a dimension 406 and a dimension 408) that fits within the dimension 431 and dimension 432 of the memory 430 of the AI model 420. That is, the retriever 410 may retrieve enough table data from the table data 402 (e.g., the subset of table data 404) such that the subset of table data 404 fits within the column requirements, row requirements, and the like, of the memory 430.

FIG. 4B illustrates a process 400B of retrieving a subset of records from the table data 402 based on a nearest neighbor (NN) algorithm according to examples and features of the instant solution. Referring to FIG. 4B, the retriever 410 may include a k-nearest neighbor (KNN) model 412 which uses proximity between data points within a space (such as vector space) to make classifications or predictions about the grouping of data points. The KNN model 412 is a machine learning model which does not make any underlying assumptions about the data distribution.

In the example of FIG. 4B, the retriever 410 may receive a target record 440 which may include a row of data with contextual values of an entity associated with the target record 440 such as a user, an object, a location, a place, or the like. The retriever 410 may include one or more of a tokenizer, vectorizer, embedder, etc. which can convert the row of data into a vector and plot the vector in multi-dimensional vector space (not shown). In addition, the retriever 410 may convert the records in the table data 402 into vectors and plot the vectors in the multi-dimensional vector space.

The KNN model 412 may identify vectors in the multi-dimensional vector space that are closest to the vector corresponding to the target record 440. In some examples and features of the instant solution, the KNN model 412 may identify vectors that are within a predetermined distance from the target vector in the vector space and determine that these vectors within the predetermined distance from the target vector correspond to the nearest neighbors. In this case, the corresponding data records of the vectors within the predetermined distance from the target vector may be chosen/included in the subset of table data 404. In the example of FIG. 4B, the KNN model 412 identifies data record 442, data record 444, and data record 446, as the subset of vectors that are most relevant to the target data record 440.

FIG. 4C illustrates a process 400C of retrieving a subset of records from the table data 402 based on an AI model 414 according to examples and features of the instant solution. Referring to FIG. 4C, the retriever 410 may include an AI model 414 configured to identify the most relevant features/attributes within the table data 402 and select columns of data corresponding to the most relevant features/attributes within the table data 402.

Referring to FIG. 4C, the retriever 410 may receive a target task 460 to be executed by a downstream AI model, such as an in-context learning model. The retriever 410 may also retrieve metadata 451 from the table which identifies which features are stored in which columns of the table data 402. For example, the metadata 451 may include identifiers of the data attributes (types of data values) that are stored within each column. For example, when the records correspond to users, the data attributes may include attributes of the users, such as age, geographic location, income, marital status, and the like.

In this example, the retriever 410 may input the metadata 451 and/or the target task 460 into the AI model 414, and in response, the AI model 414 may determine a subset of attributes that are most relevant for the target task 460. In response, the AI model 414 may select a subset of columns including column 452, column 454, column 456, and column 458 and include them in the subset of table data 404.

In some examples and features of the instant solution, the process 400C may be used in combination with the process 400B shown and described in the example of FIG. 4B. Thus, the retriever 410 may reduce the table data in size down to the subset of table data 404 by removing both rows and columns of data from the table data 402. As another example, the retriever 410 may remove one of the rows or the columns to generate the subset of table data 404.

In some examples of the instant solution, AI model 420 in FIG. 4A, KNN Model 412 in FIG. 4B, and/or AI model 414 in FIG. 4C may be example(s) of AI model 232, described and depicted in FIGS. 2A-2C, and may have been trained in an AI development system 240 or deployed to an AI production system 230, as described and depicted in FIGS. 2A-2C.

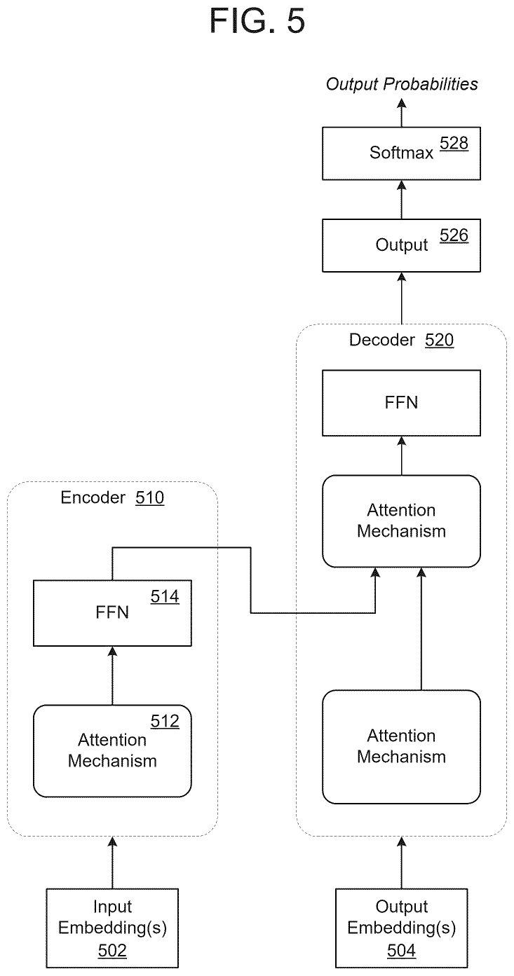

FIG. 5 illustrates an example of a transformer model according to the examples and features of the instant solution. In the examples and features of the instant solution, the transformer model includes a neural network architecture that may be an AI model or may be included within an AI model along with other components. The transformer model uses “self-attention” to learn context and relationships between different elements in an input sequence. In the examples and features of the instant solution, the input sequence may be a table, instead of a string of words, images, tokens, etc.

Referring to FIG. 5, the transformer model includes an encoder 510 and a decoder 520. The encoder 510 is configured to process an input sequence (e.g., input embeddings 502), for example, based on an input table of data, to extract meaningful representations between the elements of the input sequence. The decoder 520 uses the representations generated by the encoder 510 to generate the output sequence based on output embeddings 504. The encoder 510 may capture the context associated with the input and the decoder 520 may apply the context to create a new sequence of elements, which are then output. In some examples and features of the instant solution, the process may be iteratively performed in a loop. The loop may continue until a desired output is achieved, or some other condition is achieved such as a time limit, iteration limit, memory limit, and the like.

In this example, the encoder 510 and the decoder 520 each include at least one self-attention mechanism and feed-forward network (FFN). The self-attention mechanism allows the model to attend to different parts of the same input sequence when processing it. As an example, each token or other data element in the input sequence can consider the influence of other tokens or elements within the same sequence.

For example, a self-attention mechanism 512 may compute a context-aware representation of the input sequence which includes attention weights for each element in the input sequence, allowing the transformer to dynamically adjust its attention to the most relevant parts of the input. For example, for a sentence “The cat sat on the mat,” the self-attention can cause the model to recognize that the element “mat” is more related to the element “on” than to the element “The” within the input sequence.

As another example, an FFN 514 may introduce non-linearity into the model, which helps capture complex relationships within the input data. The FFN 514 may receive the context-aware representation of the input sequence from the self-attention mechanism 512 and may include linear transformations and a non-linear activation function (like ReLU or GELU). The FFN 514 may enhance the expressive power of the transformer by enabling the model to learn more nuanced and complex representations of the input data.

The model also includes an output 526 layer that transforms the model's internal representation into a more interpretable format, such as word probabilities or the final output sequence. It typically involves a linear transformation followed by a softmax 528 layer. The output 526 layer prepares the model's predictions for downstream tasks, such as language translation, text generation, or question answering. Meanwhile, the softmax 528 layer converts the output of the model into a probability distribution over the possible outcomes. It may normalize the output scores, to ensure that the probabilities sum up to one. Softmax may be used to calculate attention weights and to generate probabilities for the next word in a sequence during text generation or translation.

FIG. 6A illustrates a process 600A of generating global context according to the examples and features of the instant solution. According to various examples and features of the instant solution, the input data that is input to the transformer model described herein may include tabular data, for example, a database table, a spreadsheet, or the like. Referring to FIG. 6A, tabular data 610 includes a plurality of rows and a plurality of columns of data thereby creating a two-dimensional array of cells where data is stored. The tabular data 610 may include labels that are applied to the rows and the columns thereby identifying the type of data stored therein.

In the examples and features of the instant solution, the model described herein may extract rows of data from the tabular data 610 (or columns of data), and convert the extracted rows into data points (e.g., row A is converted into data point 611, etc.) which are then fed as a sequence into a transformer model. For example, in FIG. 6A, a vectorizer (not shown) may be included within the transformer, or upstream from the transformer, and may generate a plurality of data points 631, 632, 633, 634, 635, 636, 637, 638, 639, and 640, from a plurality of rows A, B, C, D, E, F, G, H, I, and J, respectively, within the tabular data 610. These data points may be referred to as global context including all of the elements in the sequence, along with the impact/influence the elements have on each other.

The conversion may include extracting the contents from a row and converting the entire row of content into a vector that is stored in multi-dimensional space, such as shown in the example of FIG. 6C. For example, each row may be considered a data record that includes a plurality of data values of different types associated with a user, or some other entity. As an example, a user's demographic data (e.g., age, location, race, family history, etc.) may be stored within a plurality of cells of a row. Here, the system may extract the entire row of content and convert it into a single vector that is then plotted in vector space.

FIG. 6B illustrates a process 600B of replacing the global context with local context according to the examples and features of the instant solution. In the examples and features of the instant solution, the self-attention mechanism of a transformer model may replace the global context with local context, thereby reducing the weights on the elements, the number of elements, or the like, which are considered by the model during processing. Referring to FIG. 6B, the model generates a global context 630 with the plurality of data points 631, 632, 633, 634, 635, 636, 637, 638, 639, and 640, from the plurality of rows A, B, C, D, E, F, G, H, I, and J, respectively, within the tabular data 610. Although not shown in FIG. 6B, the self-attention mechanism 622 may also receive an indicator that the data point 635 is a query data point/query vector that is the target of an incoming request such as the target 118 in the example of FIG. 1A.

The global context 630 may be input to a transformer 620 with a self-attention mechanism 622. Here, the transformer 620 may be part of an AI model. The self-attention mechanism 622 may use at least one algorithm or function to identify local context 650 from the global context 630. For example, the self-attention mechanism 622 may execute the algorithm on the plurality of data points 631, 632, 633, 634, 635, 636, 637, 638, 639, and 640, including the query data point 635 (referred to herein as a query vector), that is associated with the input request. In response, the self-attention mechanism may identify a subset of elements (e.g., data points 632, 636, and 638 which are related to the query data point 635.

Here, the self-attention mechanism 622 may replace the global context 630 with local context 650 that includes the data points 632, 636, and 638 which are related to the query data point 635. The self-attention mechanism may remove or otherwise modify the weights of the other data elements to restrict how much consideration is given to them by the model. The local context 650 may be input to downstream tasks of the transformer model including a FFN 652 for further processing. The local context 650 may be referred to as a context-aware representation 654 of the input sequence.

FIG. 6C illustrates a process 600C of determining the local context according to the examples and features of the instant solution. According to various examples and features of the instant solution, the self-attention mechanism may execute an algorithm, for example, a proximity detection algorithm that identifies a distance between two data points (e.g., data elements, etc.) in the input sequence. The proximity detection process may be performed for the input sequence with respect to a target query vector.

For example, the proximity detection process may identify relevant data points (vectors, key vectors, rows of a table, columns of a table, etc.) that are within a predetermined proximity threshold of the query data point in vector space and use the relevant data points as local context. The local context can be used instead of the global context and can greatly reduce the amount of processing performed by the transformer model by reducing the data that is stored in memory, reducing the data considered by the model, reducing complexity, and the like.

Referring to FIG. 6C, the self-attention mechanism 622 may include a proximity detection model 623 that may receive the plurality of data points 631, 632, 633, 634, 635, 636, 637, 638, 639, and 640, and plot the data points in vector space 660. Here, the plurality of data points is plotted as vectors in the vector space 660. In this example, the proximity detection model 623 generates a proximity threshold 662 around the vector 635v corresponding to the query data point. In this example, the self-attention mechanism identifies the vectors that are inside the proximity threshold 662, including a vector 632v, a vector 636v, and a vector 638v, and generates the local context based on these vectors, while the remaining vectors are discarded or otherwise have their weights reduced to reduce the consideration of the remaining vectors when generating a response to the query data point.

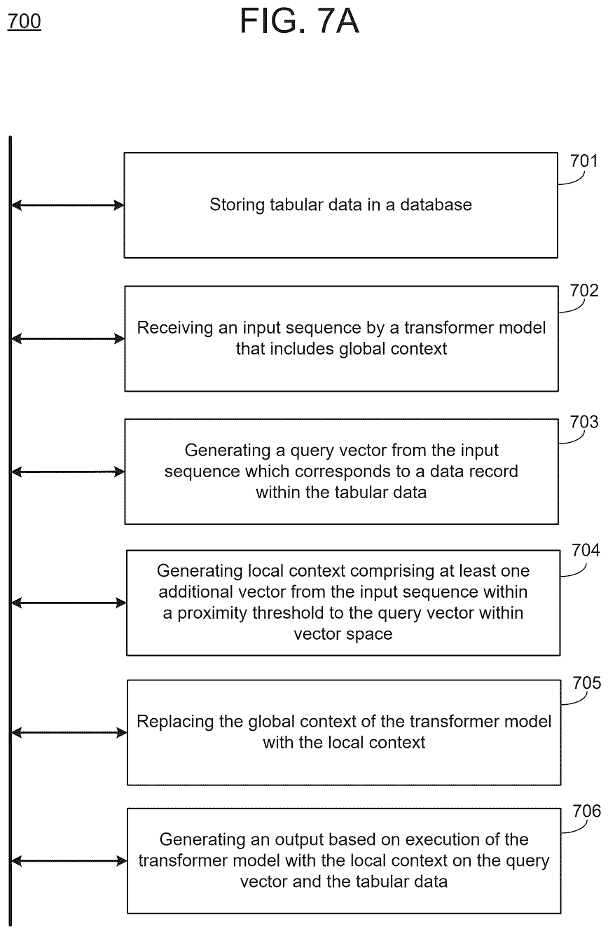

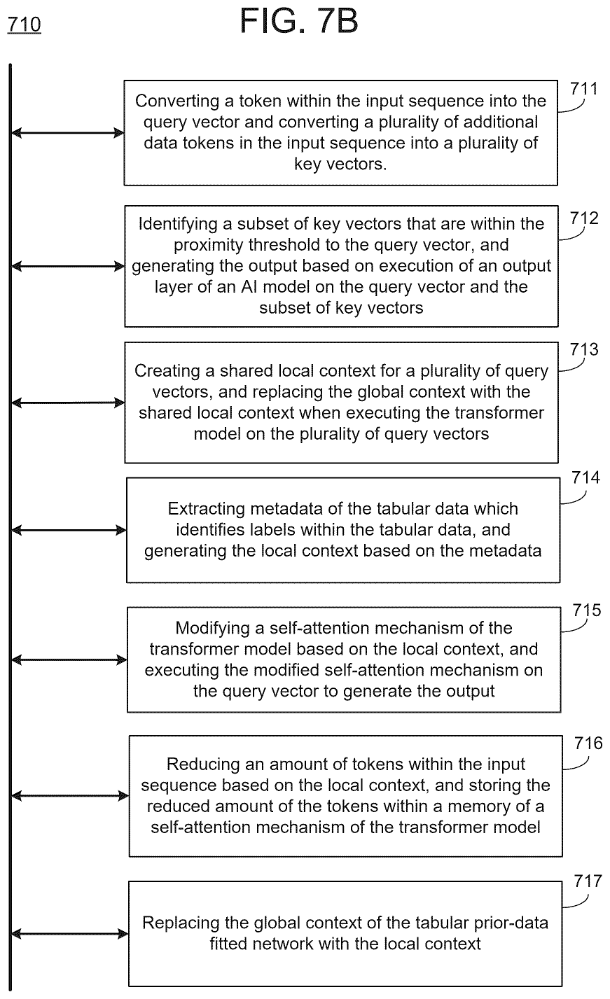

FIG. 7A illustrates a method 700 of replacing global context with local context according to examples and features of the instant solution. For example, the method 700 may be performed by a host platform such as a cloud platform, a web server, a software application, a combination of systems, and the like. Referring to FIG. 7A, in 701, the method may include storing tabular data in a database. In 702, the method may include receiving an input sequence by a transformer model that includes global context. In 703, the method may include generating a query vector from the input sequence, wherein the query vector corresponds to a data record within the tabular data. In 704, the method may include generating local context comprising at least one additional vector from the input sequence within a proximity threshold to the query vector within vector space. In 705, the method may include replacing the global context of the transformer model with the local context. In 706, the method may include generating an output based on execution of the transformer model with the local context on the query vector and the tabular data.

FIG. 7B illustrates a method 710 of replacing global context with local context according to examples and features of the instant solution. For example, the method 710 may be performed by a host platform such as a cloud platform, a web server, a software application, a combination of systems, and the like. Referring to FIG. 7B, in 711, the method may include converting a token within the input sequence into the query vector and converting a plurality of additional data tokens in the input sequence into a plurality of key vectors. In 712, the method may include identifying a subset of key vectors that are within the proximity threshold to the query vector within the vector space, and generating the output based on execution of an output layer of an artificial intelligence (AI) model on the query vector and the subset of key vectors.

In 713, the method may include creating a shared local context for a plurality of query vectors, and replacing the global context with the shared local context when executing the transformer model on the plurality of query vectors. In 714, the method may include extracting metadata of the tabular data which identifies labels within the tabular data, wherein the generating the local context further comprises generating the local context based on the metadata. In 715, the method may include modifying a self-attention mechanism of the transformer model based on the local context, and executing the modified self-attention mechanism on the query vector to generate the output.

In 716, the method may include reducing an amount of tokens within the input sequence based on the local context, and storing the reduced amount of the tokens within a memory of a self-attention mechanism of the transformer model. In 717, the transformer model may include a tabular prior-data fitted network trained on a labeled set of tabular feature data, and the replacing may include replacing the global context of the tabular prior-data fitted network with the local context.

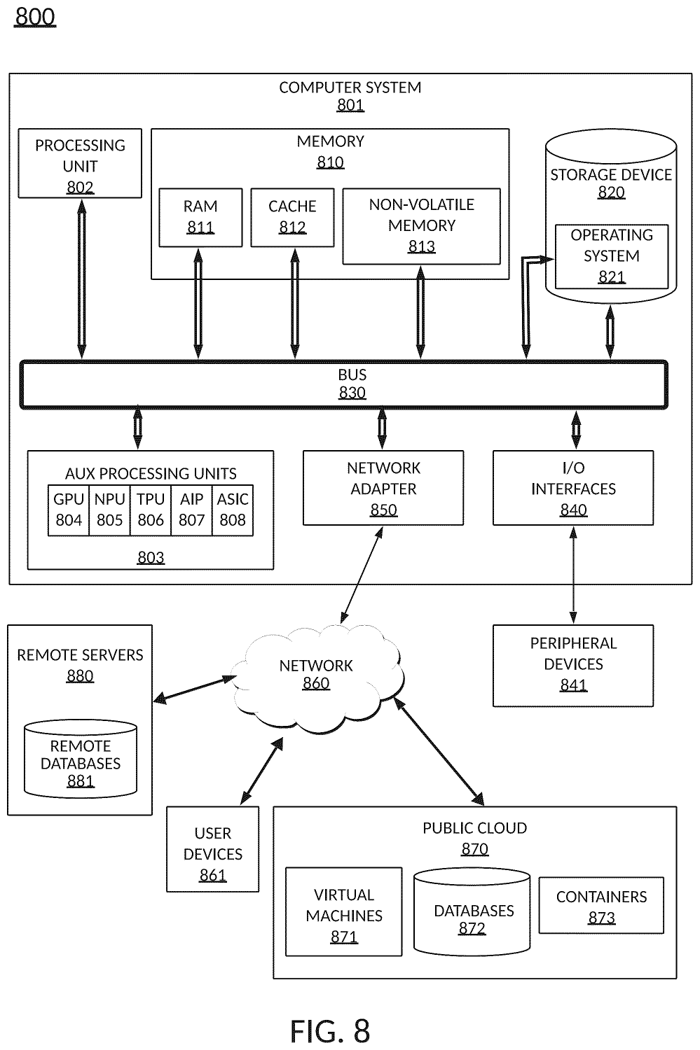

The examples and features of the instant solution may be implemented in one or more of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. As shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

Memory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc.; at least one device that enables a user to interact with computer system 801; and/or any devices (e.g., network card, modem, etc.) that enable computer system 801 to communicate with at least one other computing devices. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN), a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LANs designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. User devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system APIs and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

In one example of the instant solution, the retriever component may be further configured to identify and rank features of a target data record based on a weighted relevance score calculated from prior execution results of the transformer model. In this example, metadata representing the feature origin, frequency of influence, or prior classification correlation is used to weight each candidate column of the tabular data. The retriever then filters out features falling below a predetermined score threshold, thereby dynamically constructing a compressed input matrix for inference, while preserving semantic alignment with the original decision intent.

In another example of the instant solution, a shared local context may be established across a group of query vectors when the query vectors exhibit similarity within vector space. In this configuration, the retriever identifies a neighborhood cluster of queries, computes a unified proximity threshold based on centroid positioning, and applies this unified threshold to form a shared context vector set. This shared local context is passed into the transformer model for batch inference, enabling more efficient use of memory resources and increasing throughput when performing multi-query inference tasks.

In another related configuration, the self-attention mechanism of the transformer model may be modified to include a gating function that dynamically adjusts attention weights based on historical proximity profiles. This allows the transformer model to apply context prioritization strategies, such as boosting underrepresented attributes within the context window or emphasizing features associated with past misclassifications, thus enhancing the adaptability of the attention mechanism to non-stationary tabular environments.

In further aspects of the instant solution, the retriever integrates with a monitoring component configured to track transformer model execution statistics and adjust future context generation parameters accordingly. For example, when inference latency exceeds a threshold, the retriever may adjust the proximity threshold to generate smaller local contexts or selectively reduce the dimensionality of vector representations using a feature compression mechanism, all while preserving predictive utility.

In a practical application of the instant solution, a user interacts with the instant solution via device, such as a tablet or smartphone, that executes a decision-support application powered by a transformer-based AI model. The user may enter personal or contextual data, such as demographic attributes, current goals, or behavioral indicators, into a user interface displayed on the device. This information is converted into an input sequence, from which the transformer model identifies a query vector representing the target data record. The retriever component of the instant solution dynamically generates a local context by identifying and extracting a subset of vectors from a tabular dataset stored in memory that are within a defined proximity threshold to the query vector in vector space. This local context is used in place of the full global context, allowing the AI model to execute a prediction operation in a single pass. For example, the AI model may generate a recommendation that is visually rendered to the person via the display of the device.

What is claimed is:

1. An apparatus comprising:
a memory configured to store tabular data; and
a processor communicatively coupled to the memory, the processor configured to:
receive an input sequence by a transformer model that includes global context;
generate a query vector from the input sequence, wherein the query vector corresponds to a data record within the tabular data;
generate local context comprising at least one additional vector from the input sequence within a proximity threshold to the query vector within vector space;
replace the global context of the transformer model with the local context; and
generate an output based on execution of the transformer model with the local context on the query vector and the tabular data.

2. The apparatus of claim 1, wherein the processor is further configured to convert a token within the input sequence into the query vector and convert a plurality of additional data tokens in the input sequence into a plurality of key vectors.

3. The apparatus of claim 2, wherein the processor is further configured to identify a subset of key vectors that are within the proximity threshold to the query vector within the vector space, and generate the output based on execution of an output layer of an artificial intelligence (AI) model on the query vector and the subset of key vectors.

4. The apparatus of claim 1, wherein the processor is further configured to create a shared local context for a plurality of query vectors, and replace the global context with the shared local context when executing the transformer model on the plurality of query vectors.

5. The apparatus of claim 1, wherein the processor is further configured to extract metadata of the tabular data which identifies labels within the tabular data, and further generate the local context based on the metadata.

6. The apparatus of claim 1, wherein the processor is configured to modify a self-attention mechanism of the transformer model based on the local context, and execute the modified self-attention mechanism on the query vector to generate the output.

7. The apparatus of claim 1, wherein the processor is further configured to reduce an amount of tokens within the input sequence based on the local context, and store the reduced amount of the tokens within a memory of a self-attention mechanism of the transformer model.

8. The apparatus of claim 1, wherein the transformer model comprises a tabular prior-data fitted network trained on a labeled set of tabular feature data, and the processor is configured to replace the global context of the tabular prior-data fitted network with the local context.

9. A method, comprising:
storing tabular data in a database;
receiving an input sequence by a transformer model that includes global context;
generating a query vector from the input sequence, wherein the query vector corresponds to a data record within the tabular data;
generating local context comprising at least one additional vector from the input sequence within a proximity threshold to the query vector within vector space;
replacing the global context of the transformer model with the local context; and
generating an output based on execution of the transformer model with the local context on the query vector and the tabular data.

10. The method of claim 9, further comprising converting a token within the input sequence into the query vector and converting a plurality of additional data tokens in the input sequence into a plurality of key vectors.

11. The method of claim 10, further comprising identifying a subset of key vectors that are within the proximity threshold to the query vector within the vector space, and generating the output based on execution of an output layer of an artificial intelligence (AI) model on the query vector and the subset of key vectors.

12. The method of claim 9, further comprising creating a shared local context for a plurality of query vectors, and replacing the global context with the shared local context when executing the transformer model on the plurality of query vectors.

13. The method of claim 9, further comprising extracting metadata of the tabular data which identifies labels within the tabular data, wherein the generating the local context further comprises generating the local context based on the metadata.

14. The method of claim 9, further comprising modifying a self-attention mechanism of the transformer model based on the local context, and executing the modified self-attention mechanism on the query vector to generate the output.

15. The method of claim 9, further comprising reducing an amount of tokens within the input sequence based on the local context, and storing the reduced amount of the tokens within a memory of a self-attention mechanism of the transformer model.

16. The method of claim 9, wherein the transformer model comprises a tabular prior-data fitted network trained on a labeled set of tabular feature data, and the replacing comprises replacing the global context of the tabular prior-data fitted network with the local context.

17. A computer-readable storage medium comprising instructions which when executed by a processor cause the processor to perform:
storing tabular data in a database;
receiving an input sequence by a transformer model that includes global context;
generating a query vector from the input sequence, wherein the query vector corresponds to a data record within the tabular data;
generating local context comprising at least one additional vector from the input sequence within a proximity threshold to the query vector within vector space;
replacing the global context of the transformer model with the local context; and
generating an output based on execution of the transformer model with the local context on the query vector and the tabular data.

18. The computer-readable storage medium of claim 17, wherein the processor is further configured to perform converting a token within the input sequence into the query vector and converting a plurality of additional data tokens in the input sequence into a plurality of key vectors.

19. The computer-readable storage medium of claim 18, wherein the processor is further configured to perform identifying a subset of key vectors that are within the proximity threshold to the query vector within the vector space, and generating the output based on execution of an output layer of an artificial intelligence (AI) model on the query vector and the subset of key vectors.

20. The computer-readable storage medium of claim 17, wherein the processor is further configured to perform modifying a self-attention mechanism of the transformer model based on the local context, and executing the modified self-attention mechanism on the query vector to generate the output.
